(19) United States
(12) Patent Application Publication
(10) Pub. No.: US 2002/0156702 A1
(43) Pub. Date: Oct. 24, 2002

(54) System and method for producing, publishing, managing and interacting with e-content on multiple platforms

(76) Inventor: Benjamin Kane, Herzeliya (IL)

Correspondence Address: SWIDLER BERLIN SHEREFF FRIEDMAN, LLP, 3000 K STREET, NW, BOX IP, WASHINGTON, DC, 20007, US

(21) Appl. No.: 09/886,613

(22) Filed: Jun. 22, 2001

Related U.S. Application Data
(63) Continuation-in-part of application No. 09/602,541, filed on Jun. 23, 2000.

(51) Int. Cl. G06F 17/60

(52) U.S. Cl. 705/27

(57) ABSTRACT

A system and method for producing, publishing, distributing, managing and interacting with rich content items over one or more platforms, comprising a plurality of database servers, application servers, web servers, and a hierarchical intelligent broadband network constructed of network servers (resource root server, Network servers, Edge servers, and cache machines). A system and method are provided which are able to provide rich content infrastructure via an intelligent hierarchical network capable of optimizing data storage and transfer to user clients and end users. The network allows remote manipulation of every object of data on a content item display composed of images, video clips, sound files, and text files. It combines object-oriented methodology with multimedia layering techniques using a database for content item and resource management. The present invention culminates in the creation and management of abstract—generic, whereby content is created once, and distributed, converted and accessed from anywhere, on all platforms.

### RELATED APPLICATIONS

This application is a continuation-in-part of U.S. patent application having U.S. Ser. No. 09/602,541 filed Jun. 23, 2000.

### FIELD OF THE INVENTION

The present invention relates, in general, to an electronic content management system, and more particularly to a system and method for enabling content developers to produce, publish, manage, distribute and convert content to multiple platforms, and end-users to interact with rich content on multiple platforms.

### BACKGROUND OF THE INVENTION

High speed Internet access can open up a new world of collaborative multimedia entertainment and interactive communications. In e-commerce, products and/or services are advertised at web sites using multimedia (video, animation, voice, and text) applications, interactive communications, and other rich content and high volume traffic. Currently, most DOT.COM sites use static and simple product presentation to display and advertise their products. As a result, there is reluctance among consumers to browse and view products and/or services on the Internet.

The Internet as a platform to convey information is becoming a very complex and competitive environment. Instead of one narrow band platform we have witnessed the emergence of multiple Internet platforms. An enterprise must engage with a multiple platform environment in order to reach all its information recipients. In order to compete for the attention of the viewer the information designer must use compelling and engaging displays. But above all the enterprise has to deal with a growing volume of information and information diversity that must be produced, managed and updated on a daily basis and in a collaborative effort, while maintaining a high level of impact across thousands of pages.

Demand for heavy multimedia traffic is expected to quadruple in the next few years. The need to keep up with this increase has stimulated the development of new approaches for fast and high volume data streaming solutions, such as broadband-Integrated Services Digital Network (B-ISDN) and Asynchronous Transfer Mode (ATM) networks. Wireless Internet communication is dramatically expanding via cellular, PDA and other Internet devices. There is also a growing need for tools to publish distribute and manage content over large enterprise Intranets. All the above factors suggest a need for a unifying approach for producing, publishing, managing and viewing content over multiple platforms.

In the early days of the Internet the main concept for content structure was the Hypertext philosophy. It challenged the way people comprehended information—mainly challenging the traditional linear structure. This approach basically laid the assumption that every piece of information has a unique structure. The structure was the way the piece of information is broken to segments and how these segments are linked to each other. The unique structure is responsible for the “Effectiveness” of the presentation. Templates based Content Management tools emerged to answer the growing demand for managing and updating large content bases. Templates suggest an opposite, unifying approach to the structure in which information is presented.

With today's technology an enterprise with a large content base and many information channels and platforms faces a tough decision. Either structure and manage the content in a traditional web site—using the customization approach of Hypertext, or incorporate one of many Web Content Management (WCM) products in the market. The first is impossible when it comes to terabits of assets and thousands of pages. The second is inefficient since it uses templates as its core technology. Templates ease the way large knowledge bases are managed but lack the customization ability to fit different look and feel and structure to diverse information. The science of information correlates between the way information is introduced and the level of the recipients' comprehensiveness, and business decisions making. The unified structure and look & feel imposed by the template approach over a diverse body of information results in the production of ineffective web pages. There is a real need for an information solution that will offer a “Template Free” WCM system that offers efficient management of wide bodies of knowledge, while enabling the freedom to customize information structure and style.

Compelling displays with rich content and interactions are expensive to produce. It requires the know-how of HTML and JAVA languages. Templates, Dynamic pages and Forms require PERL, CGI or JAVA programming. In addition, the linear HTML format makes it almost impossible and extremely difficult to develop pages that use OO (Object Oriented) methodology over a multi-layering architecture. The common web design is associated with the “Table” structure where every change in the page affects the entire page.

There is therefore an urgent need for content production tools that incorporate the new XML protocol with the 00 methodology to enable the production of articulated displays that are competitive and effective.

There is a further need for a system and method that unifies the production, delivery and display of content for all content platforms under one set of high quality, easy to use tools and methods.

There is a further need for a tool that enables user-friendly production of platform-independent content without a deep prior knowledge of programming.

Furthermore there is a need for a tool to manage the content over multiple platforms that enables easy and fast editing of specific pages, sections and the entire knowledge base without affecting the availability and responsiveness of the content.

Finally there is an urgent need to provide a means for enabling automated updating of content, such that a change in one platform representation of the content can take effect on various mirror sites simultaneously web content without manually synchronizing between mirror sites and databases, and the other platforms that the content is represented in.

Today's web sites technology generally uses a “One to Many” central approach to provide user access to content. According to this approach there is one web site that serves many users. In order to reduce bottlenecks one should have mirror sites where all the web site content is duplicated. This duplication of content, programs, and databases creates a major problem in web site synchronization and content management across mirror sites. There is need for a complete automated solution for content management and scalability that dramatically reduces the inefficiencies in managing mirror sites.

### SUMMARY OF THE INVENTION

The present invention relates to a system and method for enabling content developers to produce, publish, manage, distribute and convert content to multiple platforms, and end-users to interact with rich content on multiple platforms.

The present invention provides a system for producing, publishing, distributing, managing, and viewing content over multiple platforms. The present invention can be applied to converting content for many different platforms, including web based systems, printers, content executable forms (e.g. executable files), web TV and wireless application protocol (WAP) platforms. A web based system can include: (a) Production server, (b) a Web Content Management (WCM) server farm with database servers, application servers, and web servers, and (c) A hierarchical intelligent broadband communications network (PSIN—Producer System Interactive Network) constructed of one or many PSNS (Producer System Network Servers) capable of communicating with each other and with user clients. The PSNS is constructed of a web server with hooked proprietary handlers.

The present invention successfully addresses the shortcomings of the presently known systems and methods for producing, publishing, distributing, and viewing content on multiple platforms, by providing a unified and efficient system and method capable of utilizing the elements of the invention described below, that is crucial to increase acceptance of the described system in the e-content market.

The present invention provides solutions for the above listed needs, by offering a system that:

1. Unifies the process of producing content for multiple platforms

2. Provides easy to use production tools that uses the object-oriented (OO) methodology in a multiple layering architecture

3. Enables “Template Free” design and customization of content

4. Provides a full suite of servers, tools and services for updating and managing large volume of content

The present invention introduces a different approach to content developers through an innovative Object Layering Architecture and the introduction of the PKI (Product Knowledge Item). In accordance with the present invention a user may generate top-notch content, with no need for programming. The following refers to the described embodiment as “The Producer System.” Since the content uses a layering architecture, changes do not affect other elements in the content and thus are very easy to manage. The auto-generation of platform code provides high level capabilities across platforms. For example, the auto-generation of the HTML code takes care of browsers' incompatibilities on the object level, and thus, provides high-level display capabilities across browsers. The PKI provides a middle management layer between the global content (e.g., web site) and the single page, and thereby provides more flexibility with reduced management efforts.

Implementation of the method and system of the present invention involves performing or completing selected tasks or steps manually, automatically, or a combination thereof. Moreover, according to actual instrumentation and equipment of preferred embodiments of the method and system of the present invention, several selected steps could be implemented using hardware or software, on any operating system of any firmware or a combination thereof. For example, using hardware, selected steps of the invention could be implemented on a chip or a circuit. As software, selected steps of the invention could be implemented as a plurality of software instructions being executed by a computer using any suitable operating system. In any case, selected steps of the method of the present invention could be described as being performed by a data processor, such as a computing platform, for executing a plurality of instructions.

The production module of the present invention includes a production subsystem for creating at least one Product Knowledge Item (PKI) for multiple platforms, and a publisher client for publishing at least one Product Knowledge Item (PKI) for multiple platforms. In an example of the invention the Production system produces PKI XML files for storing generic source information for PKIs. The production module further comprises:

i. A WYSWYG authoring system for integrating PKI displays; and

ii. A Preview module for previewing the PKI displays in alternative platforms that include at least one platform converter and platform rule-sets.

The production module can further include Object Oriented layered architecture for constructing and managing PKI displays.

The Content Management server can comprise a Web Content Management server farm module that module can include

a) a publishing server for processing published content;

b) a system database for processing and storing assets of the published content in a system database repository;

c) a plurality of web servers for distributing the content to multiple platforms; and

d) a content management module for managing the content.

The hierarchical communications network of the present invention can be, for example, is an interactive intelligent network (Producer System Interactive Network—PSIN) that includes a plurality of Producer System Network Servers (PSNS) for serving end users, wherein each the PSNS comprises server software for serving optimized content to end users.

A further embodiment of the present invention is a system for automatically converting XML files to an alternative platform. For example, the present invention has a mechanism for automatically converting XML files to an HTML platform.

The present invention further provides a method for providing a content management system for content creation and delivery over multiple platforms.

A further preferred embodiment of the present invention is a system for supporting a “Virtual Web Site”. The virtual web site provides a complete automated solution for content management and scalability that dramatically reduces the inefficiencies in managing mirror sites.

It must be appreciated by someone skilled in the arts that the technology of the present invention can be used to create many more embodiments, and the embodiments discussed here are meant for the purpose of providing examples, and in no way limit the development of further embodiments based on the technology discussed herein.

According to further features of the present invention, the Production servers are designed and configured to produce and update content for multiple platforms, and to publish this content to a the Producer System WCM Farm.

According to yet further features of the present invention the production servers are designed and configured to produce PKIs for distribution on multiple platforms such as Narrow band, Broadband, wireless, set-top boxes, desktops, and Internet devices.

According to yet further features in preferred embodiments of the invention described herein the production servers uses an Object Oriented approach to assemble a PKI. The PKI is constructed of pages objects where each page incorporates “Display Objects”. Each object is made of a resource and attributes.

According to yet further features in preferred embodiments of the invention described herein the production servers uses a layering architecture for constructing the single display. Each object is placed in a separate layer. Manipulating an object in a page affects only the object layer—leaving all other objects in the page untouched.

According to still further aspects of the present invention, the production tool enables the production of articulated displays including full screen animation, video, 3-D effects, music and sound effects, and text.

According to still further aspects of the present invention, the production tool connects to previously published resources on the database servers to make use of these resources in a PKI.

According to yet further features in preferred embodiments of the invention described herein the production server generates an XML file that includes the structure and display instructions for an entire PKI. The XML is a hierarchical structure made of the following levels:

Platform->Page->Object->Object Attributes

According to yet further features in preferred embodiments of the invention described herein, the production servers build a resource library for a PKI. All the resources participating in a PKI are stored in the PKI resource library.

According to yet further features in preferred embodiments of the invention described herein the production server uploads (publishes) the PKI to the Producer System WCM Farm. In the upload process the PKI resource library and the PKI XML file are transferred to the Producer System WCM Farm.

According to further features in preferred embodiments of the invention described herein the production server includes converter programs that convert the displays in a PKI XML file to platform specific displays. The XML to HTML converter is one example of these converter programs.

According to another aspect of the present invention the above converter server uses a library of rule-sets to generate the HTML code of an object out of the XML object attributes.

According to further features in preferred embodiments of the invention described herein the application servers on the Producer System WCM Farm are in charge of registering and storing new PKIs that are uploaded to the Producer System WCM Farm.

According to yet further features in preferred embodiments of the invention described herein, the application servers in the present invention register every resource in a PKI resource library using the database servers, and store it in the farm storage area.

According to yet further features in preferred embodiments of the invention described herein, the application servers in the Producer System WCM Farm updates the PKI XML file with the resources registration data and stores it in the farm storage area.

According to yet further features in preferred embodiments of the invention described herein, the database servers in the Producer System WCM farm are designed and configured for registering and updating PKI resources and XML files.

According to yet further features in preferred embodiments of the invention described herein, the database server stores the registered resources information in a resource record that include the resource original name, the resource GRN (the Producer System Resource Number)—unique number assigned by the database, the PKI(s) it belongs to, the resource owner, and other fields for managing the resource in the future.

According to yet further features in preferred embodiments of the invention described herein, the database servers are further designed and configured to store and manage resources, regardless of any PKI structure. This includes adding, removing, and editing resources.

According to yet further features in preferred embodiments of the invention described herein, the database servers are further designed and configured for receiving, storing, and updating client records and consumer information.

According to another aspect of the present invention the application servers on the Producer System WCM Farm effectively provide a database driven content management solution that includes management of users and content. Users management includes the ability to add, remove and group users, to define user access permission to the management tools various functions, and to the intranet and extranet hosts. PKI management offers the ability to create, configure, remove, and schedule distribution of PKIs to all or some of the associated platforms.

According to yet another aspect of the present invention the application servers on the Producer System WCM Farm are in charge of preparing the resources and XML files for distribution of the PKIs to their targeted platforms. Valid targets are PSIN Servers (PSNS) for the public Internet and WAP, intranet desktops, special devices, and set-top boxes.

According to another aspect of the present invention the web servers on the Producer System WCM Farm are in charge of distributing the PKI resources and XML files to the targeted hosts.

According to another aspect of the present invention the PSNS includes web servers for storing distributed content, servicing end-users requests for content, allocating and transferring static resources and allocating and redirecting end-users to available PSNS's for streaming media.

According to yet another aspect of the present invention the web servers on PSNS are designed and configured to interface with end users and to determine the type of end user such as narrow-band or broadband user, and whether the user is using Intranet desk-tops, smart set-top boxes or dedicated devices.

According to yet another aspect of the present invention the web server on a PSNS is designed and configured to communicate with end users entering a user client web site in order to view PKIs.

According to a further aspect of the present invention, the web server is designed and configured to hold and, upon request, provide the appropriate content according to the consumer connection speed and display device. (PC, POS, set-top box, wireless device, etc).

According to another aspect of the present invention a web servers on PSNS includes a converter in charge of converting Internet platform displays in a PKI XML file to HTML pages.

According to another aspect of the present invention the converter web server uses a library of rule-sets to generate the HTML code of an object out of the XML object attributes.

According to another aspect of the present invention there is provided a method for producing, publishing distributing and viewing content over multiple platforms, the method comprising the steps of providing hierarchical intelligent broadband communications networks, production software tools for creating PKIs, publication software tools for publishing PKIs to the Producer System WCM Farm, Distribution software tools for distributing the content to the various platforms and PSNS viewing software tools for servicing end users requests for content.

The above method further comprises the steps of providing database servers, application servers, web servers, and PSIN servers all capable of communicating with each other and with user clients via a hierarchical intelligent broadband network.

According to another aspect of the present invention, a system is in place for providing an network infrastructure for reliable, fast and efficient content delivery, over broadband communication lines, the system comprising a plurality of database servers, a plurality of application servers, a plurality of web servers, and a plurality of PSIN Servers (PSNS), capable of communicating with each other and with a plurality of user clients. The servers, forming a hierarchical network, designed and configured for dynamically, optimizing storage of resources across the network in a single object resolution, monitoring servers load, and routing resources requests based on predetermined criteria such as QoS, and resource type.

According to yet another aspect of the present invention PSIN is designed and configured for identifying broadband and/or narrow-band consumer communications.

According to yet further aspect of the present invention PSIN is further designed and configured for enabling consumers with broadband communications to utilize the full capacity of the broadband communications to view rich content PKIs.

According to still further aspect of the PSIN-is further designed and configured for enabling consumers with narrow-band communications to view narrow-band versions of the PKIs using the same viewing mechanism.

According to still further aspect of the present invention the web servers on PSNS are designed and configured for constantly monitoring the network and, based on specific criteria, routing consumer, and/or user client requests for content to other PSNS.

According to another aspect of the present invention there is provided a method for providing a network infrastructure for reliable and efficient content delivery over both broadband and narrow-band communication lines. The method for this comprises the steps of: providing a hierarchical network comprised of database servers, application servers, web servers and a plurality of PSNS. This network provides specific application servers for monitoring and accumulating metrics on network performance, provides a specific algorithm for load balancing and storage optimization across the network in a single object resolution, and provides tools for dynamically routing requests for resources to the least loaded servers based on predetermined criteria such as contracted Quality of Service (QoS), geographic location, and type of resources requested.

According to yet another aspect of the present invention, there is included a means for facilitating all aspects of Web site production, management and usage based on an object layering architecture and the use of Product Knowledge Items (PKI or simply PKI). The PKI serves as a middle management layer provided between the global web site and a single page, providing user-friendly site management.

According to yet another aspect of the present invention, web sites are no longer static or dynamic collections of data placed on a single or plurality of Web servers. Rather, web sites according to the present invention are virtual sites whereby site data may be scattered throughout a network. This ensures increased flexibility and easier management of sites.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in the cause of providing what is believed to be the most useful and readily understood description of the principles and conceptual aspects of the invention. In this regard, no attempt is made to show structural details of the invention in more detail than is necessary for a fundamental understanding of the invention, the description taken with the drawing making apparent to those skilled in the art how the several forms of the invention may be embodied in practice.

In the drawings:

FIG. 1: illustrates a typical structure of a web site constructed of PKIs.

FIG. 2: is an overview showing the interaction possibilities of the system servers with external and internal entities.

FIG. 3: is a schematic system structure showing the layout of the system servers and the network architecture.

FIG. 4: illustrates the HTTP syntax for requesting PKIs according to the present invention.

FIG. 5: illustrates the Servicing of a non-hosted PKI from a PSNS, according to the present invention.

FIG. 6: represents a typical XML conversion of an object to a platform specific code.

FIG. 7: illustrates the XML to HTML conversion workflow according to the present invention.

FIG. 8: represents the Content flow in and out of the Producer System WCM Farm

### DESCRIPTION OF THE PREFERRED EMBODIMENTS

The present invention is a system and method for providing an end-to-end solution for producing, publishing, distributing, managing and viewing content over multiple platforms.

Specifically, the present invention provides the necessary modules/tools for producing PKIs (Product Knowledge Items), publishing PKIs to the Producer System WCM Farm, and distributing the PKIs to PSIN servers and targeted hosts on enterprise Intranets—thus enabling user clients and consumers to view and manage content over multiple platforms. The present invention further enables end-to-end remote manipulation and update of any display object due to the layering and Object-oriented architecture without effecting the overall display.

The Following Internal Terminology Applies to the Forthcoming Description of the Embodiments

The term “the Producer System” is the generic name given to the embodiment herein described, and also forms a part of various components of the invention herein described.

1. Object: the building block element of the Producer System Display Architecture. Every display is constructed out of objects. The object may be an animation, a button, an image, the background, or any other element of the display. It comprises, for example, an asset, Object Attributes (OA) and the Object Rule Set (ORS).

2. Object Attributes: (OA) A set of parameters that describes the object layout and behavior within the context of a display. These attributes may include the X, Y position of the object in the display, Size of the object, animation path, Asset name, etc. These parameters are stored in, for example, a PKI XML file.

3. Object Rule Set: (ORS) A set of instructions that together with the object attributes is used to build the code for an object in a specific platform display. The Object Rule-sets reside in the Object Rule-sets Library on every PSIN (the Producer System Interactive Network—see below) node and forms a part of the installation of the present invention.

4. Asset: Any resource that an object uses. This can be text, images, animation, streaming video/audio, Shockwave, Flash, etc.

5. Platform Converter: A program that preferably, but not necessarily resides on every PSIN (the Producer System Interactive Network—see below) node and comprises part of the Producer System Producer installation. It combines the object attributes with the object rule-set to generate code for an object in a specific platform based on the code. An embodiment of the present invention introduces the XML to HTML converter for all Internet platforms. The system of the present invention has an open-ended architecture that enables the addition of platform converters for other platforms that use a different coding for displaying content such as printer files, executable files (e.g., “exe files”), Web TV and WAP platforms.

6. Theme: An object that nests other objects. As an object, the theme may have attributes, a Rule-set and assets of its own—as well as the ones that belong to its nested objects. Themes are used to provide consistency of look and feel across displays and PKIs (Product Knowledge Items—see below).

7. Display: A logical entity that holds objects that appears in a screen. As used in the examples discussed herein, the Display also has an ID within a PKI.

8. Product Knowledge Item: (PKI) A group of displays that inter-link and together deliver a body of knowledge. The PKI comprises an XML file that holds displays for the platforms that the PKI was defined to work with, and can include a library of assets. The XML file is a generic representation of content that can be applied to any current or future Internet or non-internet content platform.

9. Multi-platform: Internet and Intranet platforms such as Narrow band, Broadband, Set-top boxes, Wireless, local desktops, printer platforms, executable files (e.g., “exe files”) and WAP, etc.

10. Internet Browser: All Internet browsers. Internet Browsers include browsers the exemplary embodiment discussed herein contemplates browsers that are compatible to the 4.0 versions of Netscape and MSIE. Also Included are versions of mini browsers that support HTML layers.

11. Producer System Network Server (PSNS): The building block of the Producer System Interactive Network (PSIN, See below). For example, an embodiment of the present invention contemplates a SUN/Solaris machine and other servers and software systems that are in charge of servicing end-users, propagating requests for resources to other PSNS's and optimizing the availability of content throughout PSIN. Typically, PSNS in PSIN are similar and differ only in their position in the network topology.

12. PSIN Node: One or many PSINS, that can be connected to or include the function of one or many Caching machines, and one storage device.

13. PSIN: Producer System Interactive Network. A hierarchical intelligent communications network, comprising a hierarchical topology of PSIN Nodes organized in layers. The layers can include, for example, a caching layer, an edge layer, a network layer, and a global layer.

14. Web Content Management (WCM) A generic term including a system or a group of software systems specializing in managing the production and maintenance of content such as, for example, web content. The Enterprises that purchase and incorporate these software systems can assign registered users to specific tasks in the content production cycle and publish the finished work.

15. WCM Server Farm: A collection of one or more servers and/or programs that provides enterprises with WCM capabilities.

16. Display Web Server (DWS) A server in charge of communicating with end-users. Preferably this server is installed on every PSNS. (See PSNS above)

17. WYSWYG authoring system-what you see what you get. WYSWYG refers to the ability to viewing the end result while editing the display.

18. Alternative platform—HTML as used in the following descriptions is an example of a platform that uses a unique display format (HTML) and a unique workflow, and is distributed among the PSIN servers. The examples discussed herein divide platforms into two main categories: Workflow platforms and protocol platforms. Workflow platforms usually require a unique definition of the workflow of publishing and distributing the content. Enterprise Intranet hosts and stations are common examples. The content they display is HTTP/HTML but they display it from their local storage, which requires a unique workflow that distributes this content to their local file storage. WAP platform is an example of an alternative platform that uses the same workflow as the Internet platform, but incorporates a unique delivery and display protocol. Other alternative platforms include XML, DHTML, printer files, executable files (e.g., “exe files”), and any other current or future data display platforms.

19.PKIXML file—The PKIXML file is one of the outputs of an embodiment of the production system. In an embodiment discussed herein, this is standard XML file (See below) that holds PKI display data for its defined platforms.

20. XML—Extensible Markup Language. This is a markup language that, unlike HTML, includes tags that may hold articulated data structures in a hierarchy.

21. Producer System Resource Number (GRN)—A number or identifier of an asset or XML file that reaches the WCM farm for publishing. In the illustrative embodiments discussed herein, the assets or XML files are registered in the main database and are stored in the farm main assets repository. Upon registration, the database provides a unique GRN for each asset or file. The publishing server links the asset and its GRN and, as needed, updates other assets entries in the PKIXML file to the new GRN.

22. DOM (Document Object Model)—A general name for the technology of parsing files, such as an XML file. A commercially available technology that can be used is Xerces. As those skilled in the art recognize, it is a library of functions and APIs that provides navigation tools between the various hierarchy level of a XML file and tools to locate, extract or update specific data.

The principles and operation of the present invention may be better understood with reference to the drawings of an embodiment of the invention and the accompanying descriptions.

Before explaining at least one embodiment of the invention in detail, it is to be understood that the invention is not limited in its application to the details of construction and the arrangement of the components set forth in the following description or illustrated in the drawing, nor to the exact, specific language of the definitions set forth above, which are intended as working definitions useful in understanding the concepts of the present invention. The invention can be implemented in various embodiments and practiced or carried out in various ways. Also, it is to be understood that the phraseology and terminology employed herein is for the purpose of description of an embodiment, and should not be regarded as limiting the invention to a particular embodiment.

Hereinafter, the term “host ” generally refers to a computer and includes, but is not limited to, personal computers (PC) having an operating system such as DOS, Windows™, OS/2™ or Linux; Macintosh™ computers; computers having JAVA™-OS as the operating system; and graphical workstations such as the computers of Sun Microsystems™ and Silicon Graphics™, and other computers having an operating system such as a version of the UNIX operating system, such as AIX™ or SOLARIS™ of Sun Microsystems™; or any other known and available operating systems; personal digital assistants (PDA), cellular telephones having Internet capabilities, set-top boxes and Web TVs.

Hereinafter, the term “Windows™” includes but is not limited to, Windows2000™, Windows95™, Windows 3.x™ in which “x” is an integer such as “1”, Windows NT™, Windows98™, Windows CE™ and any upgraded version of these operating systems by Microsoft Corp. (USA). “End-user” includes but not limited to users of Desktops such as PC and Mac, point-of-sale (POS), Set-top boxes, PDAs, cellular telephones having Internet capabilities, and dedicated devices.

The present invention is a system for producing, publishing, distributing, managing, and viewing content over multiple platforms. It comprises the following basic modules, which will be discussed below:

i. a production module for producing and publishing content for multiple platforms. The production module includes a production sub-system for creating at least one Product Knowledge item (PKI) for one or more platforms, and a publisher client for publishing at least one Product Knowledge Item (PKI) to the one or more platforms.

ii. a Web Content Management (WCM.) server farm module for storing managing, processing and distributing the content produced by the production module, and

iii. a hierarchical communications network for serving end users and managing transfer of the content between the Producer System Network Servers (PSNS).

### A. Producer Module (the Producer System) and the PKI File

1. Content developed in accordance with the present invention includes Objects. An Object is an entity that includes building blocks: Examples of building blocks include:

a. Asset

b. Attributes

c. Rule Set

2. The Producer System stores the attributes of objects that participate in a PKI (Product Knowledge Item), for example, in the form of XML in a PKI XML file.

The XML file serves as a generic form—platform independent to store and transfer the PKI object attributes and the PKI structure.

3. The XML file structure describes a hierarchy such as: PKI->Platform->Display->Object->Object Attributes. (See Appendix A: Example of a PKI XML file)

4. Object attributes are parameters that describe the layout of the object within the context of content, for example, the location within a display (X, Y) and the behavior of the object within the context of the content.

5. Object Assets are generally stored in the PKI Assets library. This library contains assets that are used to display the PKI over its defined platforms.

6. Generally, the Producer System places new objects in separate layers. The content consists of many objects placed in many layers. This architecture enables the management of content at the object level. Adding, removing or changing an object will not affect the entire content. For example, a web developer may act directly on a specific object without affecting the layout of the page, providing a major relief for web developers.

### B. The PKI (Product Knowledge Items) Management Layer

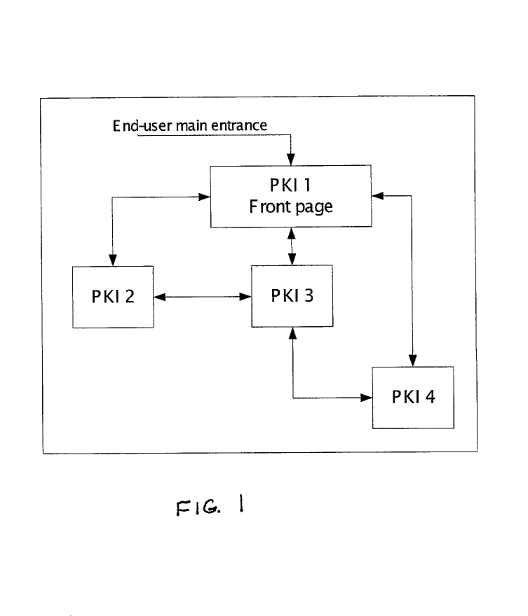

The Producer System integrates PKIs. A PKI is a group of linked displays that are targeted to one or more platforms and covers a body of knowledge. A PKI can be an independent body of knowledge or a part of a large knowledge base. In the last case a PKI is similar to a chapter in a book or a section in a web site. (See FIG. 1) For example: In the “Dot Com” common web design, the web designer can design the web site front page (PKI 1) a PKI for the company profile (PKI 2), a PKI for the Technical Support area (PKI 3) and one or many PKIs for the on-line catalog of the company (PKI 4). These PKIs can be linked by associating PKI links to buttons and text in the various PKIs. The end-user will not notice the move from one PKI to the other but from a content management point of view the designer deals with PKIs rather than with individual pages of content. In a web embodiment, PKIs in large web sites significantly eases the content management process. As can be seen in FIG. 1, various pages or objects within pages are described as individual PKIs that are linked together to form a Web site.

With current technology the design and management of a web site can be applied to the entire site or to individual pages. The Producer System PKI management tools introduce a new approach to web design and web content management. The following can be applied to every PKI:

1. Configuration

2. Design & edit—including themes for specific PKIs. For example, a web designer can apply and manage a different theme for every PKI in the web site.

3. Publishing & distribution

4. Scale-up (See following the following section: Servicing PKIs on PSIN) The new PKI management layer dramatically reduces the inefficiencies of content management in two aspects:

a) Global changes to a web site such as mirroring can be done on the level of the individual PKI. The Producer System mirrors only PKIs that are most visited.

b) The web master does not have to bother with the management of individual pages in the hundreds of pages that may make up a web site; instead, the focal point is the PKI. The web master can change it globally or just individual pages, publish it, and distribute it.

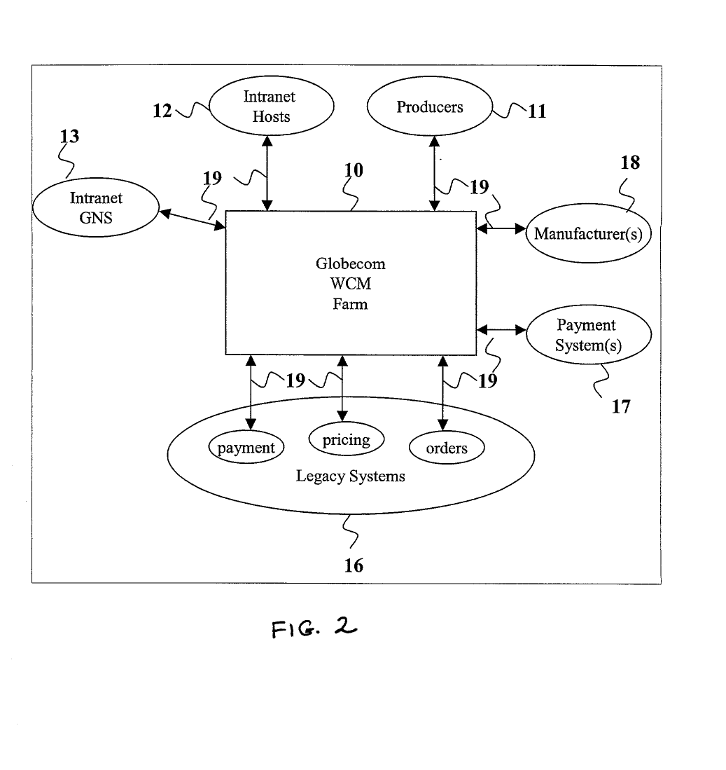

FIG. 2 is an overview showing the interactive possibilities of the Producer System WCM Farm with external and internal entities. The Producer System WCM Farm servers 10 are designed and configured to interact with various external and internal systems. The Producers 11, can be any entity that uses the production tool such as advertisers, web designers, or a client building his/her own content and loading it to the specific Producer server. Publishing the PKI is done via broadband or narrow-band communication lines 19. Intranet hosts 12 are display devices or desktops that are subscribers of the Producer System WCM content distribution service such as, but not limited to, electronic shop (e-shop) owners, department stores, content providers, customer support and training centers. As an example, Intranet PSNS 13 can be private PSIN servers that serve the enterprise Intranet. A PSNS may serve content to many Intranet hosts via local LAN or VPN. Manufacturers 18 are products and/or services sellers that use an e-commerce sub-system to handle price update, fulfillment, and refund. A PSNS may also upload (publish) to the WCM farm resources that producers will use in new PKIs. The Payment Systems 17 are external systems that provide on-line purchase of goods and services.

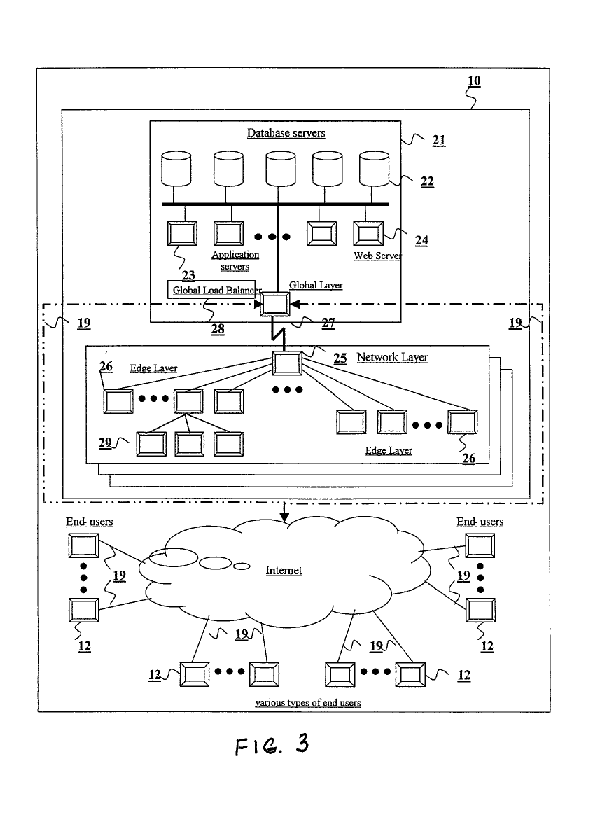

FIG. 3 is a schematic system structure showing the layout of the system servers and the network architecture. The System Servers include two main groups. The first group is the Producer System WCM Farm 21 that includes Database Servers 22, Application Servers 23, and web servers 24.

The second group is the Producer System Interactive Network (PSIN) 30. This network 30 is divided into four layers. The Global Layer server 27 is the root for content that is distributed over PSIN. It is connected to the farm storage area where, in this example, there is a copy of every distributed resource or XML file. The second layer is the Network layer 25 and the third layer is the Edge layer 26. All PSIN Servers typically include the same or substantially similar software installations, and primarily differ in their topological position. These servers manage a resource directory. As discussed above, each resource preferably has a unique identifier. The servers can include the function of, or are connected to Cache machines 29 for handling resource storage. The Cache machines 29 can comprise the fourth layer of the network.

The Database Servers 22 store and maintain data and information pertaining to resources used in an application such as, PKI XIVIL files, and information on clients, users, consumers, and external entities using or interacting with the system. Application Servers 23 is a group of application-dedicated servers used to store and run specific applications. Such applications can include the Producer, the Publisher, the Scheduler, the distribution process, the e-commerce sub-system and C&M (Control and Monitoring) applications.

### E. Servicing End-users Request for Content

A preferred embodiment of the present invention is the Producer System Virtual Web Site, which services PKIs on PSIN. According to this embodiment, viewing an HTML page requires a two-phase interaction process between the end-user and the web server that hosts the web site. In phase one, the user browser requests an HTML page. The web server that hosts the web site sends the page to the user browser. In phase two, the User browser extracts the page resources URLs from the HTML code and downloads the resources from their URLs.

While there are several technologies that addresses phase two (above) with scalable and efficient solutions, the first phase is still untouched. Lets take a closer look at what happens on the Internet today during phase one. The user browser requests the HTML page. The request is addressed to the web server that hosts the web site HTML pages. The user request is addressed to a physical web server IP address. The user enters a queue line and when his/her turn comes the web server sends him/her the requested HTML page. If the web site is using Dynamic Pages technology, the web server interacts with a backbone database to generate the page on the fly and sends the page to the requesting browser.

A web master can scale-up the access to his/her web site by using a Mirroring technology to duplicate the entire web site to another web server. The web master can manage the web site by either making global changes or change individual pages. Scaling the web site is indeed a global change. Adding a mirror site requires the addition of a Load Balancer device that redirects requests to the mirror server upon overload.

The common access to web sites content and the mirroring technology needed for scalability increases the investment in content management and web site maintenance at least the following reasons:

1. Mirroring requires the mirroring of the entire web site—regardless of the differentiation in rating between the web site pages.

2. When using Dynamic Pages, mirroring means the duplication of the entire backbone database.

The Producer System's unique technology eliminates the need for either a physical web site or its mirror sites. Scaling up access to content is done upon demand for individual PKIs. PSIN scale and manage PKIs automatically. The Producer System has developed the concept of a “Virtual Web Site”.

A “Virtual Web Site” means:

Distribute Content to a PSIN Node and access it from servers in PSIN. This concept incorporates two requirements:

1. Any server in PSIN can serve a PKI. The network should provide a way to redirect end-users HTTP requests for PKIs to PSIN servers according to pre-configured rules.

2. The selected server serves the end-user request for a PKI even if the PKI is not currently present on the server local storage or cache machine.

The described embodiment includes the following:

1. GlobalDNS

2. The Display Web Server (DWS)

3. The XML to HTML converter (X2H)

4. Handler for providing requests for resources to other PSIN servers. (Static Resource Locator web handler (SRL) and Streaming Resource Redirector (SRR))

5 1. Global DNS

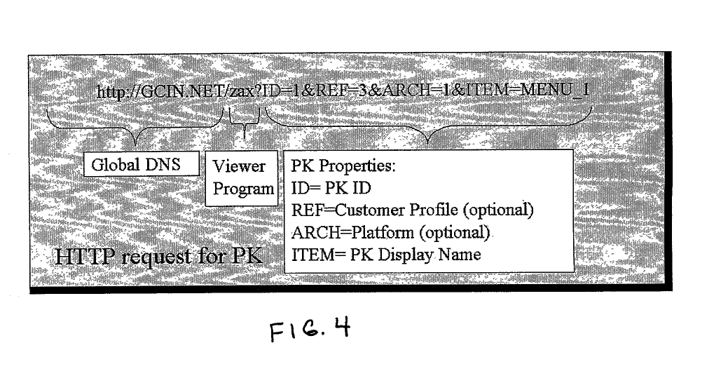

The web based embodiment uses a Global DNS as the generic URE for its HTTP requests for PKIs. See FIG. 4 for the syntax of the HTTP message used by the end-user browser to request a PKI. The first segment of the message uses the Global DNS.

The Producer System uses a standard “Global Load Balancer” Appliance. The load balancer can be installed in the main server farm (28 in Drawing 3). All the requests for PKIs that the user ISP could not track through its proxy should be handled by this device. Preferably, the appliance is configured to provide the IP address of a PSIN Node that:

1. Is closest to the end-user geographic location

2. Has enough bandwidth and CPU availability to service another end-user.

The other parameters in the message are used by DWS (See point 2. below) to send the right page to the user.

2. The Display Web Server (DWS)

DWS is a C++ component. In a preferred embodiment, the DWS includes an Apache web server, and is installed for PSIN nodes. DWS has three basic functions:

1. It interacts with the end-users. It gets HTTP requests for PKI pages and it sends the HTML pages and resources to the requesting users.

2. It activates if necessary the X2H to convert XML to HTML pages. (See Converting XML to HTML section)

3. It redirects requests for resources to SRL and SRR. These handlers are in charge of providing the request for resources that where not found on the PSNS storage throughout PSIN. (The process for providing requests is described in details in Providing Request for Resources section below).

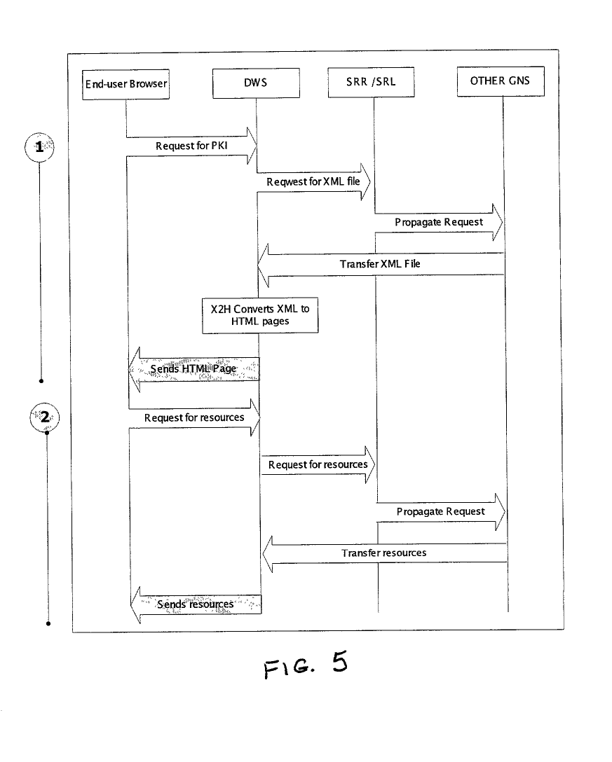

The workflow shown in FIG. 5 illustrates an example of how a PSNS serves a request for a PKI that does not exist in its storage, i.e., the storage does not contain, for example, the PKI HTML pages, the PKI XML file and the PKI resources.

Step 1

In this step DWS provides the requested HTML page to the end-user browser. DWS checks first if the HTML page associated with the user request exists already on the PSIN Node Storage. If the page exists, DWS sends it immediately to the end-user browser. Since in our scenario the page does not exist, DWS searches for the PKI XML file. Since the XML file does not appear in the PSNS storage, DWS activates the SRL. The PKI XML file is treated in PSIN as just another static resource. SRL propagates the request to other PSIN Servers. The XML file is found and transferred to the requesting PSNS, and an X2H handler converts the page automatically to the PKI HTML pages. Once the requested page has been converted, DWS sends the page to the end-user browser.

Step 2

In this step DWS provides the end-user browser with the assets needed for the display of the HTML page. Since the assets do not appear on the PSIN Node storage, it activates SRL (Static Resource Locator) and SRR (Streaming Resource Redirector) handlers to propagate the request to other PSIN Nodes.

3. The Producer System Convert

A Producer System Converter converts content to a specific viewing format or platform. An example of a Producer System Converter is a system that converts XML to HTML.

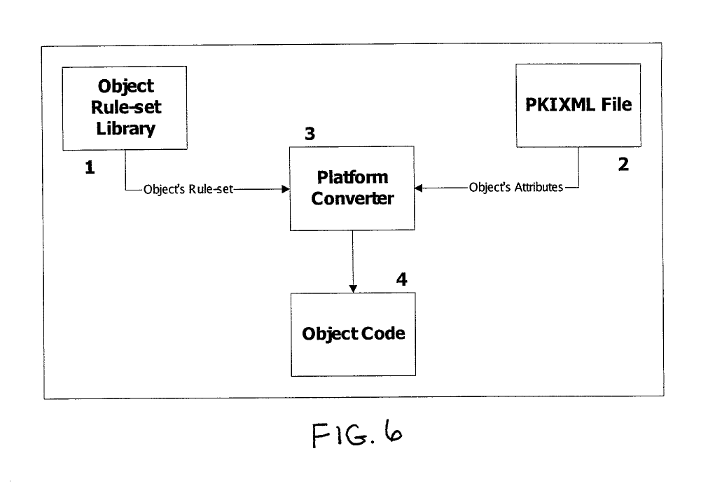

In a preferred embodiment of the present invention, the Producer System Converter uses three modules to generate a platform conversion of the PKI XML file to a desired platform code. These can be seen with reference to FIG. 6.

i) The PKIXML file 62. The PKI contains the displays hierarchy for the various platforms, and the display Object Attributes.

ii) The Objects Rule-sets 61 are used to convert the XML element (object) to a valid platform code. Rule-sets are available to PSNS and comprise part of the Producer's preview module. The Rule-sets for the HTML-Internet platform uses HTML and JAVA Script code. (See Appendix B: Examples of Rule-sets).

iii) The Platform Converter 63 uses the Object Rule-set and Object Attributes to generate the code 64 for the display of an object in a specific platform display.

The present invention's XML to HTML conversion is an implementation of the Producer System Display Architecture for the Internet-HTML platform. The XML to HTML converter programs can reside in the Producer System: The Production System and the PSNS.

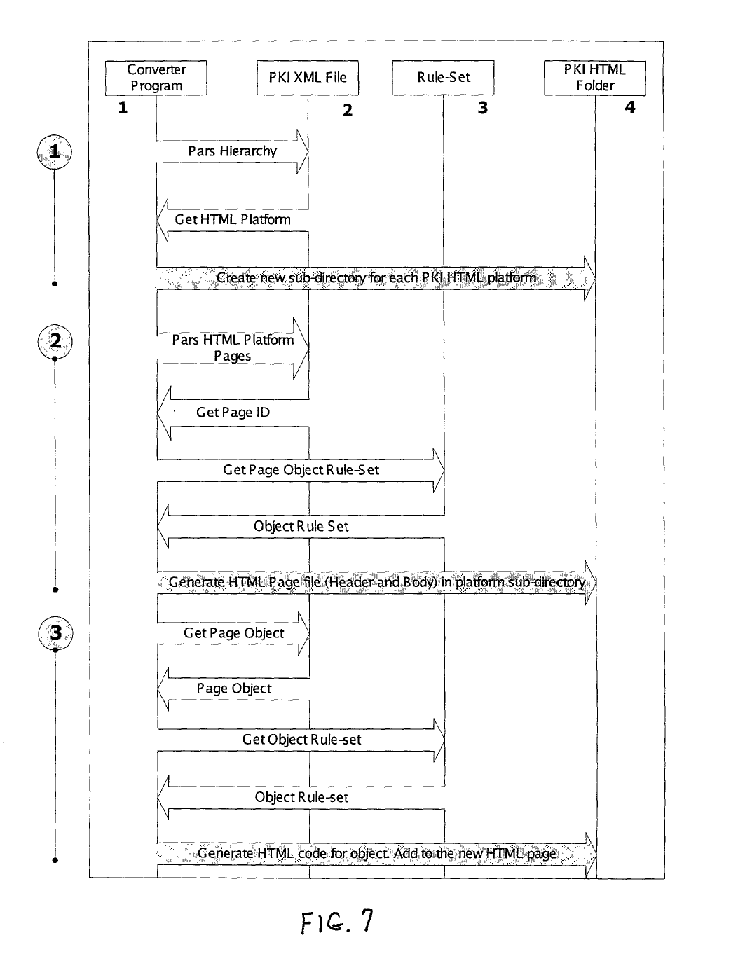

iv) The conversion technology and workflow used by the two components described above is similar. The conversion workflow can be seen in FIG. 7.

Step 1

As mentioned above, the XML file describes a hierarchy: Platform->Page->object->object attributes. In step 1 the converter program (1) parses the first hierarchy level of the PKI XML File (2). The converter program (1) parses the XIVIL file using the DOM protocol and extracts the PKI HTML—platforms. For each platform it creates a new folder under the PKI main HTML folder (4). Each platform has an ID used for naming the new folders. The PKI XML file (2) may include non-Internet platforms that use other software for viewing the PKI content. Such platforms may be Intranet devices. The HTML converter does not parse the non-Internet platforms. The local storage disk may look as follows after step 1.

Folder: (PKI Name)

Folder: 1 (ID of Broadband platform)

Folder: 2 (ID of Narrow band platform)

Step 2

The converter program (1) parses the second hierarchy level of the PKI and extracts the page attributes. This includes the display ID, valid domains references, etc. In this example, the platform ID and display ID are included in the HTML page ID, which preferably is a unique ID. It now browses the Rule-sets (3) and loads the Page Rule-set (See Appendix B—Page Rule-set). It generates the HTML code for the basic page and saves the page under the platform folder (4)—using the display ID for naming the page. After step 2 the local disk will look as follows:

Folder: (PKI Name)

Folder: 1 (ID of Broadband platform)

Main.html

1 .html

2 .html

Folder: 2 (ID of Narrow band platform)

Main.html

1 .html

2 .html

3 .html

Step 3

Now the converter (1) builds the HTML code for the first object in the first HTML page. It starts by parsing the PKI XML file (2) to retrieve the object attributes. (Third and fourth levels of the hierarchy) The converter program (1) loads the Object Rule-set (3) that matches the object type. Then, the converter program (1) adds the Object Attributes to their appropriate placeholders in the loaded Rule-set. Finally the converter program (1) adds the assembled code to the HTML document as a new layer in the page—using the DIV tag. Browsers that support layers place everything between two HTML DIV tags in a separate layer. If an object incorporates other objects—like in the Theme object, the converter program (1) parses all the child objects within a parent object and adds the entire parent HTML code to the final page. The converter program (1) repeats step 3 until all the objects of the display are properly extracted and converted to layers in the final HTML page.

The converter program (1) repeats step 2 and 3 until all the displays of a PKI are properly converted to layered HTML pages that are inter-linked.

### Dynamic Objects

A Dynamic Object is an object, where some of its attributes are not hard-coded but are generated on the fly using information stored either on the Producer System or the content owner legacy systems. The concept is similar to the dynamic pages technology but it is applied to the object level rather than to the entire page. The Price quote function can be used to describe how it is implemented with a Dynamic Object.

i) i. the Producer System incorporates a library of Dynamic Objects. The web designer can add a Dynamic Object to a display or to a theme. For example, when a Price Dynamic Object is added to a display, it is reflected immediately in the PKI XML file.

ii) The Dynamic Object has attributes such as Product SKU number, and other parameters that refer to the legacy of the thing associated with a PKI.

iii) The Dynamic Object is matched to a Rule-set on PSIN Rule-set Library. The XML to HTML Converter uses the Rule-set to generate the HTML code for the object.

iv) In general, the code will include an HTTP request directed to a server application on the referrer PSNS. The syntax of this HTTP string can include a reference ID of the display or a product SKU number, the target legacy, customer profile and/or additional application-specific parameters. In our example, the Price object will provide the server application on the PSNS with the product SKU number, target legacy and the customer profile.

v) The PSNS will initiate a query of the targeted legacy and return the information to the object on the user browser.

vi) The price quote is displayed on the user browser.

Advantages of XML to HTML Platform Conversion

1. No need for XML/HTML programming know-how. The Producer System or the PSIN Node generates both the XML and HTML code automatically.

2. “Free Form” approach to web pages design. Every object in a page holds the layout attributes for its layer in the page. Unlike Dynamic Pages technology, there are no layout constraints such as templates on the graphic designer.

3. Due to the automatic code generation, the content creator can assemble articulated objects with JAVA scripts and high level HTML design without writing a single code line. Many objects provide interactivity that due to budget constrains may be created with plug-ins.

4. Computability between browsers is addressed in the Object Rule-set level by using IF/THEN JAVA script commands. The graphic designer should focus on the look & feel of the display. When delivering content to Internet users, the Producer System Converter builds the HTML pages that are compatible to all browsers. This compatibility is built in into the HTML page and the user browser follows the IF/THEN conditions to select the right HTML code to execute. There is no need for ASP/JSP/CGI programs on the server side to detect the user's browser type and send the appropriate HTML page.

5. The web developer can use Dynamic Objects to generate specific content on the fly without any restrictions on the overall graphic layout or writing HTML code.

4. Providing Requests for Resources

The PSNS distinguishes between two different requests for resources: (1) streaming resources, and (2) static resources. There are two handlers that take care of requests propagation: SRL (Static Resource Locator) and SRR (Streaming Resource Redirector). The SRR uses the following procedure (which is provided as an illustration only) to allocate streaming resources and to redirect the end-user to the PSNS that will serve the streaming. The description below refers to FIG. 3.

i) Locate the resource on descendents (Edge server 26 has none).

ii) If negative, locate the resource on local storage.

iii) If negative, propagate request for the resource to a higher level in the hierarchy (The Network Server 27)

iv) This is a DFS (Deep First Search) type of procedure that ensures that all the branches of the hierarchy will be searched. When the Edge Layer server 26 gets a request for a streaming resource, the server 26 operates as follows: The server 26 checks if the resource exists on any of the server's “descendent” servers or on its storage. (In the case of the Edge Layer server 26, there are no descendents to check upon). If the response is negative, the server sends the request to the Network Layer server 25. The Network server 25 executes the same or similar procedure. If the answer is still negative, the server sends the request to the Global Layer Server 27 in the server farm and again executes the same or similar procedure on all descendent Network servers 25. When one or many appearances of the resource are found, their URLs are sent back to the querying ancestor server. The ancestor server selects—using pre-defined rules—one URL and sends this URL back to its ancestor. This process ends when the Edge server 26 gets the best performing URL and generates a “Redirection File” using Real Networks or MS Media protocols. DWS sends the file to the end user browser or various other types of end user 32 mechanisms. The Browser uses the file to connect to the redirected PSNS video server and streams the resource.

Upon a request for a static resource the DWS executes the SRL handler (Static Resource Locator). The SRL uses the following procedure to retrieve resources:

i. Check existence of resource on local storage;

ii. If negative, send query for resource to a higher level

When the Edge Layer server 26 gets a request for a static resource, the Edge server operates as follows: the Edge server 26 checks for the resource in the Edge server's 26 storage. If the resource exists, the Edge server 26 downloads the resource to the end user mechanism, such as a browser 32. If the resource does not exist, the Edge server 26 passes a request for the resource to the Network server 25. The Network server executes the same procedure and upon a negative result passes the request to the Global Server 27 in the server farm. Typically, a static resource resides at least on the Resource Root Server 27. The resource is cached either from the Network server 25 or Resource Root Server 27 down to the Edge server 26, and is downloaded from there to the end user browser 32.

### F. Dynamic Scalability on a PKI Level

Based on the above description, it can be seen that a PKI that was not initially distributed to a PSNS was installed there on the fly. From a PSIN high-level overview we can say that PSIN “Scaled-up” the PKI to another PSNS. It increased by one the number of PSNS that can serve directly PKI HTML pages without propagating. The PKI scale-up was done on the fly with a minimal effect on the response time thanks to the direct wide bandwidth connection between PSINs.

The scenario above describes a PKI scalability invocation by a user request. This is one way the PKI scalability process takes place. PSIN incorporates a powerful optimization engine that uses either off-the-shelf or proprietary algorithms to monitor the PKIs usage and load across the network. The choice depends upon the application and in not critical to the present invention. This engine can initiate a scale-up of a PKI to other PSNS using probability results from the on going PSIN analysis.

### G. Removing Content from PSIN

PSIN uses a rule base approach to manage the content. Every PKI is registered and distributed on PSIN with a management policy made of rules. PSIN uses these rules to manage the content automatically. For example a PKI can be distributed with the following rules:

1. Place all PKI HTML and assets in the Gin Node “Temporary Caching Area”.

2. If an HTML page or asset was not used for more than 24 hours remove the page or asset from the storage.

The above rules add to the auto-scalability of a PKI, and by that enable automation of PKI management over the distributed PSIN servers. A PKI may be associated with a different set of rules:

1. Place all HTML and assets of a PKI in the PSIN Node “Permanent Storage”

2. Allow manual removal only.

The above rules allow an Auto-scalability for the PKI and a manual removal. The many variations of rules result in an open, highly customizable, and fully automated content management solution.

### H. The Database Use in the System of the Present Invention

In today's web technology the database has two major uses:

1. The database serves as the web site repository for data. It holds, for example, product SKUs prices, catalog structure, users, assets, or other data.

2. The database takes an active role in generating the web site pages. This is the case when using Dynamic Pages technology.

While it is agreed that the database approach is the best tool to manage a web site repository, the second use is controversial. Although Dynamic Pages technology scores in creation and content management of new pages, it has three serious drawbacks that jeopardize the whole use of this technology.

1. It uses hard-coded templates on the web server in the form of CGI scripts or JSPs to provide the layout of the generated pages. This is a major obstacle in customizing pages in a web site to serve different products, or to use different structures of information. Programming templates is a costly operation and web masters try to keep them to a minimum.

2. The database can become a bottleneck when hits get to a high peak.

3. When scaling up the web site there is a need to mirror the database as well.

Keeping integrity and synchronization between two or more databases using replications and other database methods is considered a challenge reserved to expert DBAs only.

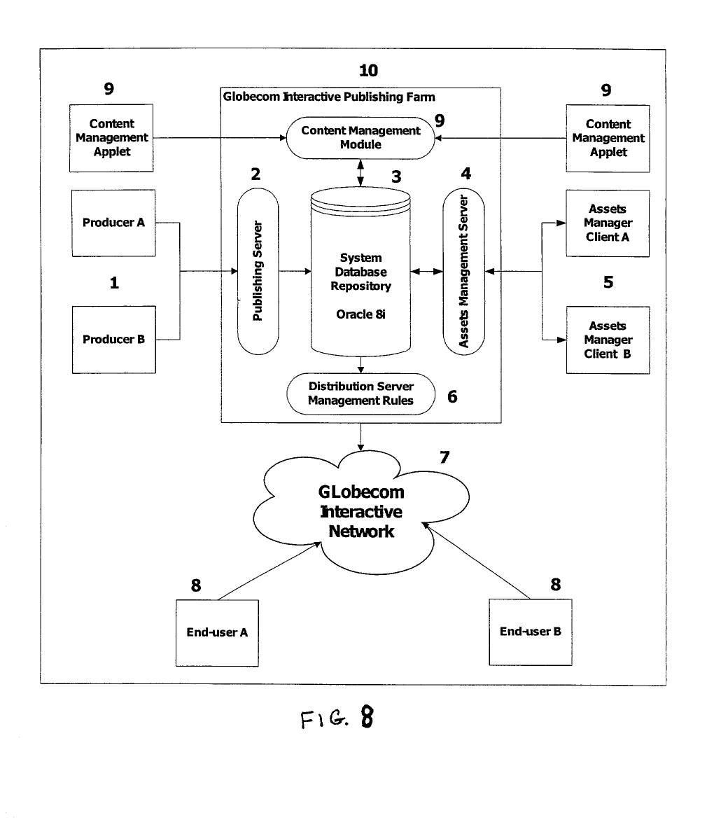

The System of the present invention currently uses Oracle 8i as its repository database for pre-distributed content. The system uses a Rule Base approach to manage the distributed content. (As described in the above section) FIG. 8 illustrates the flow of content to and from the Producer System Interactive Publishing Farm. It shows that although the Producer System makes an extensive use of the database approach while publishing and managing pre-distributed content, there is no need to use databases in PSIN. According to FIG. 8, producer Systems (101) publish PKIs to a WCM farm (110). The Publishing Server (102) registers all the coming assets and PKI XML Files in the Database Repository (103) and assigns a GRN for every file. Subsequently, assets are managed via the database.

Digital Assets Management (DAM) is a 3 party system that is integrated in WCM Farm. Assets Management Clients (105) uploads/downloads individual assets via the Assets Management Server (104). These assets are also registered in the database and get GRNs. Production Systems can browse through the assets and download them through the database (103) queries and pre-defined searches. Content Management users (109) manage the content by manipulating records and tables in the database. (103)

The Distribution Server (106) uses the database (103) to prepare the distribution of a PKI to the alternative platforms. It queries the database for scheduled distributions. It also queries the database for the files that belong to a scheduled PKI and prepares the files for distribution.

Generally, PSIN does not utilize the database. New content gets to the distributed layer and old one is removed using management rules.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media such as floppy disc, a hard disk drive, RAM, and CD-ROM's, as well as transmission-type media, such as digital and analog communications links.

Although the invention has been described in conjunction with specific embodiments thereof, it is evident that many alternatives, modifications, and variations will be apparent to those skilled in the art. Accordingly, it is intended to embrace all such alternatives, modifications and variations that fall within the spirit and broad scope of the claims.

APPENDIX A
An example of an XML file according to the present invention

<?xml version=”1.0” standalone=”no”?>
<PKI>
<PLATFORM ID=”1” NAME=”No Name”>

<PAGE ID=”Menu_1” BGCOLOR=”#006B63” GOTOPAGE=”Menu_2 .html”>
<TITLE>Menu 0</TITLE>
<TEXTSTYLE FONT=”Arial” COLOR=”white” SIZE=”22”

ALIGNMENT=”CENTER” ID=”ICICO”/>

<TEXTSTYLE FONT=”Arial” COLOR=”black” SIZE=”22”

ALIGNMENT=”CENTER” TD=”shadowICICO”/>

<ICON X=”171” Y=”209”W=”200” H=”150”>
<PlC GRN=”1” TYPE=”image/jpeg” OGRN=”file://d:/gb02/amazons.jpg”/>
<ALT>yyy yyy yyy</ALT>

<TEXT STYLE=”ICIC0” X=”171” Y=”391” W=”200” H=”35”> <ROLL>1 11

222 333</ROLL>

<SHADOW X=” 173”Y=”39 1” W=”200” H=”3 5” STYLE=”shadowICIC0”/>

</TEXT>
<ACTION GLD=”Menu 2”/>
</IC ON>

<ICON X=”653” Y=”209” W=”200” H=”150”> <PlC GRN=”1”
TYPE=”image/jpeg” OGRN=”file://d:/gb02/andrews.jpg”/> <ALT></ALT>

<ACTION GID=”Menu_3”/>
</ICON>

<TEXT STYLE=”ICIC0” X=”653” Y=”39 1” W=”200” H=”3 5”> <ROLL>eee eee
eee</ROLL>
</TEXT>
</PAGE>
<PAGE D=”Menu_2” ANCESTOR=”Menu_1” BGCOLOR=”#FFFFFF”> <ICON
X=”0” Y=”0” W=”1024” H=”768”>
<PlC GRN=”1” TYPE=”image/jpeg” OGRN=”file://d:/gb02/background.jpg”/>

</ICON>
<TITLE>1 11 222 333</TITLE>
<TEXTSTYLE FONT=”Arial” COLOR=”#000000”SIZE=”22”

ALIGNMENT=”CENTER” ID=”ICICO”/>

<TEXTSTYLE FONT=”Arial” COLOR=”white”SIZE=”22”

ALIGNMENT=”CENTER”ID=”ddd”/>

<ICON X=”146” Y=”209” W=”200” H=”150”> <PlC GRN=”1”
TYPE=”image/jpeg” OGRN=”file://d:/gb02/bathsheba.jpg”/><ALT>eeee</ALT>
<ACTION GD=”MODEL_1”/>
</ICON>
<TEXT STYLE=”ICIC0”X=”146” Y=”359” W=”200” H=”35”>
<ROLL>Model- 1</ROLL>

<SHADOW X=”149” Y=”359” W=”200” H=”35” STYLE=”ddd”/> </TEXT>

<ICON X=”4 12” Y=”209” W=”200” H=”150”> <PlC GRN=”1”
TYPE=”image/jpeg” OGRN=”file://d:/gb02/bougival.jpg”/><ALT>dddd</ALT>
<ACTION GID=”MODEL_2”/>
</ICON>
<TEXT STYLE=”ICIC0” X=”412” Y=”359” W=”200” H=”35”> <ROLL>Model-
2</ROLL>
</TEXT>
<ICON X=”678” Y=”209” W=”200” H=”150”> <PLC GRN=”1”
TYPE=”image/jpeg” OGRN=”file://d:/gb02/fort-samson.jpg”/>
<ALT>dddd</ALT>
<ACTION GID=”MODEL_3”/>
</ICON>
<TEXT STYLE=”ICICO” X=”678” Y=”3 59” W=”200” H=”3 5”>
<ROLL>Model-3</ROLL>
</TEXT>
<ICON X=”935” Y=”12” W=”72” H=”72”>
<PlC GRN=”1” TYPE”image/png” OGRN=”file://d:/gb02/BackUp.png”/>
<PICDOWN GRN”1” TYPE =”image/png”

OGRN=”file://d:/gb02/BackDn.png”/>

<ACTION CMD=”UP”/>
<ALT>Go Back</ALT>
</IC ON>

</PAGE>
<PAGE D=”Menu_3” ANCESTOR=”Menu_1” BGCOLOR=”#FFFFFF”>

<ICON X=”0” Y=”0” W=” 1024”H=”768”> <PlC GRN=”1”TYPE=”image/jpeg”
OGRN=”file://d:/gb02/background.jpg”/></ICON>
<TITLE>eee eee eee</TITLE>
<ICON X=”935” Y=”12” W=”72” H=”72”>
<PlC GRN=”1” TYPE=”image/png”OGRN=”file://d:/gb02/BackUp.png”/>
<PICDOWN GRN=”1” TYPE=”image/png”

OGRN=”file://d:/gb02/BackDn.png”/>

<ACTION CMD=”UP”/>
<ALT>Go Back</ALT>
</ICON>

</PAGE>
<PAGE ID=”MODEL 1” ANCESTOR=”Menu_2”LEFT”MODEL 3”
RIGHT=”MODEL_2” BGCOLOR=”#009C9C”>

<TITLE>Model- 1</TITLE>
<ICON X=”935” Y=”12” W=”72” H=”72”>
<PlC GRN=”1” TYPE=”image/png” OGRN=”file://d:/gb02/BackUp .png”/>
<PICDOWN GRN=”1” TYPE=”image/png”

OGRN=”file://d:/gb02/BackDn.png”/>

<ACTION CMD=”UP”/>
<ALT>Go Back</ALT>
</ICON>

```
  <ICON X=”7 13” Y=”332” W=”72” H=62” ID=”moreBut”> <PLC GRN=”1”
TYPE=”image/png” OGRN=”file://d:/gb02/more-up.png”/> <PICDOWN GRN”1”
TYPE=”image/png” OGRN=”file://d:/gb02/moredn.png”/>
  </ICON>
<ICON X=”16” Y=”696” W=”146” H=”53”>
```

<PIC GRN=”1” TYPE=”image/png” OGRN=”file://d:/gbo2fPrevUp .png”/>
<PICDOWN GRN=”1” TYPE=”image/png” OGRN=”file://d:/gbO2/PrevDn.png”/>
<ACTION CMD=”PREV”/>
<ALT>Previuse</ALT>
</ICON>
<ICON X=”861” Y=”696” W=”146” H=”53”> <PlC GRN”1”TYPE”image/png”
OGRN=”file://d:/gbO2/NextUp.png”/> <PICDOWN GRN=”1”
TYPE=”image/png” OGRN=”file://d:/gb02fNextDn.png”/> <ACTION
CMD=”NEXT”/>
<ALT>Next</ALT>
</ICON>
<ICON X=”412” Y=”275” W=”200” H=”150” ID=”IDNUM1”> <PlC GRN=”1”
TYPE=”image/jpeg” OGRN=”file://d:/gbO2/bacchus- 1 .jpg”/> </IC ON>

```
  <TEXTSTYLE FONT=”Times New Roman” COLOR=”white” SIZE=”31”1”
ALIGNMENT=”CENTER” ID=”ICIC0”/>
  <TEXTSTYLE FONT=”Times New Roman” COLOR”black”SIZE=”3 1”
ALIGNMENT=”CENTER” ID=”eti”/>
<ICON X=”629” Y=”180” W=”3 19” H=”78” ID=”IDNUM2”>
```

<PlC GRN=”1” TYPE=”image/jpeg” OGRN=”file://d:/gbO2/bacchus- 1 .jpg”/>
<TEXT STYLE=”ICICO” X=”629” Y=” 180” W=”3 19”H=”78”> <ROLL>roll
Web page truly irresistible. Here are a zillion </ROLL> <ROLL>roll 2 Member of
GSAnet Banner Swap Main Tutorials </ROLL> <ROLL>roll 3 Page HTML Java
Perl CGI Modems </ROLL> <SHADOW X”63 1” Y=”180” W=”3 19” H=”78”
STYLE=”eti”/></TEXT>

```
</ICON>
  <TEXTSTYLE FONT=”Times New Roman” COLOR=”#0000FF”SIZE=”28”
ALIGNMIENT=”CENTER” LD=”ICIC 1 “/>
  <ICON X=”65” Y=”82” W=”191” H=”121” ID=”IDNUM3”> <PLC GRN=”1”
```

TYPE=”image/png” OGRN=”file://d:/gbO2/WhiteTag.png”/> <TEXT
STYLE=”ICIC1” X=”—5” Y=”120” W=”33 1” H=”45”> <ROLL>1 11</ROLL>
</TEXT> </ICON>

<TEXT STYLE=”ICIC1” X=”339” Y=”120” W=”278” H=”39” IID=”IDNUM4”>
<ROLL>1 11</ROLL>
</TEXT>
<TEXT STYLE=”ICIC1” X=”73” Y=”23” W=”774” H=”53” ID=”IDNUM5”>
<ROLL>1 11</ROLL>
</TEXT>
<ICON X=”4 12” Y=”275” W=”200” H=”150” ID=”IDNUM6”> <PLC GRN=”1”
TYPE=”image/jpeg” OGRN=”file://d:/gbO2/bridge- 1 .jpg”/>
</ICON>

<ICON X=”629” Y=”180” W=”3 19” H=”78” ID=”IDNIJM7”>

<PlC GRN=”1” TYPE=”image/jpeg” OGRN=”file://d:/gbO2/bridge- 1 .jpg”/>

<TEXT STYLE=”ICICO” X=”629” Y=”180” W=”3 19” H=”78”>

<ROLL>roll 1 of variante 2 ndnjj jj jjj j kshxcklhsdc</ROLL>
<ROLL>roll 2 of variante 2 kjdvljfv dfvf</ROLL>
<ROLL>roll 3 of variant 2 jsdfhkjsf dshtksfd</ROLL> <SHADOW X=” 631”

Y=”180” W=”319” H=”78” STYLE=”eti”/>

</TEXT>

</IC ON>

<ICON X=”65” Y=”82” W=”191”H=”12 1” ID=”IDNUM8”>
<PLC GRN=” 1” TYPE=”image/png” OGRN=”file://d:/gbO2/WhiteTag.png”/>

<TEXT STYLE=”ICIC 1” X=”−5” Y=” 120” W=”33 1” H=”45”>

<ROLL>222</ROLL>
</TEXT>
</ICON>
<TEXT STYLE=”ICIC1” X=”339” Y=”120” W=”278” H=”39”ID=”IDNUM9”>
<ROLL>222</ROLL>
</TEXT>
<TEXT STYLE=”ICIC1” X=”73” Y=”23” W=”774” H=”53” TD=”IDNUM10”>
<ROLL>222</ROLL>
</TEXT>

<ICON X=”412” Y=”275” W=”200” H=”150” ID=”IDNUM1 1”> <PlC GRN=”1”
TYPE=”image/jpeg” OGRN=”file://d:/gbO2/brighton-beach1 .jpg”/>

</ICON>
<ICON X=”65” Y=”82” W=”191” H=”121” ID=”IDNUM13”> <PlC GRN=”1”

TYPE=”image/png” OGRN=”file://d:/gbO2/WhiteTag.png”/> <TEXT
STYLE=”ICIC1” X=”—5” Y=”120” W=”331” H=”45”>

<ROLL>333</ROLL>
</TEXT>
</ICON>
<TEXT STYLE=”ICIC1” X=”339” Y=”120” W=”278” H=”39”ID=” IDNUM14”>
<ROLL>33 3</ROLL>
</TEXT>
<TEXT STYLE=”ICIC1” X=”73” Y=”23” W=”774” H=”53”ID=” IDNUM15”>
<ROLL>3 33</ROLL>
</TEXT
<ICON X=”50” Y=”463” W=”100” H=”75” D=”IDNUM16”> <PlC GRN=”1”
TYPE=”image/jpeg” OGRN=”file://d:/gbO2/bacchus.jpg”/> </IC ON>
<ICON X=”50” Y=”463” W=”100” H=”75” IID=”IDNUM17”> <PlC GRN=”1”
TYPE=”image/jpeg” OGRN=”file://d:/gbO2/bridge.jpg”/> </ICON>
<ICON X=”5 0” Y=”463” W=” 100” H=”75” ID=”IDNUM 18”> <PlC GRN=”1”
TYPE=”image/jpeg” OGRN=”file://d:/gbO2/brighton-beach.jpg”/> </ICON>
<CONTROL>

<DMORE>moreBut</TDMORE>

<STATE>
<ROLL IDCHANGE=”IDNUM 1” IDDESCICON=”IDNUM2”

IDPRICEICON=”IDNUM3” IDCATNUM=”IDNUM4” IDCATNAME=”IDNUM5 “/>

<IDCONTROL>IDNUM 1 6</IDCONTROL>
</STATE>
<STATE>

<ROLL IDCHANGE=”IDNUM6” IDDESCICON=”IDNUM7”

IDPRICEICON=”IDNUM8” IDCATNUM='IDNUM9” IDCATNAME=”IDNUM1 0”/>

<IDCONTROL>IDNUM17</IDCONTROL>

</STATE>
<STATE>

<ROLL IDCHANGE=”IDNUM1 1” DDESCTEXT=”IDNUM12”

IDPRICEICON=”IDNUM 13” IDCATNUM=”IDNUM 14”
IDCATNAME=”IDNUM 15 “/>

<IDCONTROL>IDNUM18</IDCONTROL>
</STATE>
</CONTROL>

```
  </PAGE>
<PAGE ID=”MODEL _2” ANCESTOR=”Menu 2 ”LEFT=”MODEL 1”
RJGHT=”MODEL_3” BGCOLOR=”#FFFFFF”>
  <ICON X=”0” Y=”0” W=”1024” H=”768”>
```

<PlC GRN=”1” TYPE=”image/jpeg” OGRN=”file://d:/gbO2/backModel.jpg”/>
</ICON>
<TITLE>Model-2</TITLE>
<ICON X=”93 5” Y=” 12” W=”72” H=”72”> <PlC GRN=”1” TYPE=”image/png”
OGRN=”file://d:/gbO2/BackUp.png”/> <PICDOWN GRN=”1”
TYPE=”image/png”

OGRN=”file://d:/gbO2/BackDn.png”/>

<ACTION CMD=”UP”/>
<ALT>Go Back</ALT>
</IC ON>
<ICON X=”16” Y=”696” W=”146” H=”53”>
<PIC GRN=”1” TYPE=”image/png” OGRN=”file://d:/gbO2/PrevUp .png”/>
<PICDOWN GRN=”1” TYPE=”image/png” OGRN=”file://d:/gbO2/PrevDn.png”/>
<ACTION CMD=”PREV”/>
<ALT>Previuse</ALT>
</ICON>
<ICON X=”861” Y=”696” W=”146” H=”53”> <PlC GRN=”1”
TYPE=”image/png” OGRN=”file://d:/gbO2/NextUp.png”/> <PICDOWN GRN=”
1” TYPE=”image/png” OGRN=”file://d:/gbO2/NextDn.png”/> <ACTION
CMD=”NEXT”/>
<ALT>Next</ALT>
</IC ON>
</PAGE>
<PAGE ID=”MODEL_3” ANCESTOR=”Menu_2” LEFT=”MODEL 2”

RIGHT=”MODEL_1” BGCOLOR=”#FFFFFF”>

<ICON X=”0” Y=”0” W=”1024” H=”768”>
<PlC GRN=”1” TYPE=”image/jpeg” OGRN=”file://d:/gbO2/backModel.jpg”/>
</ICON>
<TITLE>Model-3</TITLE>

<ICON X=”935” Y=”12” W=”72” H=”72”>

<PlC GRN=”1”TYPE=”image/png” OGRN=”file://d:/gbO2/BackUp .png”/>

<PICDOWN GRN=”1” TYPE=”image/png”

OGRN=”file://d:/gbO2/BackDn.png”/>

<ACTION CMD=”UP”/>
<ALT>Go Back</ALT>
</IC ON>
<ICON X=”16” Y=”696” W”146” H=”53”>
<PLC GRN=”1” TYPE=”image/png” OGRN=”file://d:/gbO2/PrevUp .png”/>
<PICDOWN GRN”1” TYPE=”image/png” OGRN=”file://d:/gbO2/PrevDn.png”/>
<ACTION CMD=”PREV”/>
<ALT>Previuse</ALT>
</ICON>
<ICON X=”861” Y=”696” W=”146” H=”53”> <PlC GRN”1”
TYPE=”image/png” OGRN=”file://d:/gbO2/NextUp.png”/> <PICDOWN GRN”1”
TYPE=”image/png” OGRN=”file://d:/gbO2/NextDn.png”/> <ACTION
CMD=”NEXT”/>
<ALT>Next</ALT>
</ICON>

</PAGE>
</PLATFORM>
</PKI>

APPENDIX B
Examples of various Rule-sets according to the present invention

Page Rule set
<HTML>
<HEAD> <TITLE>#TITLE#</TITLE>#HEAD#
<SCRIPT>
#ROLLVARS#
pictureDivType =0;
textDivType = 1;
function manip(x, mode,type) {var it;

if (x == ”) return;
if (document.all) if (!document.all[x]) return; if (document.layers) if
(!document[x]) return;
if (mode) it = “visible”; else it = “hidden”;
shadowDivName = “shadow” + x;
if (document.layers) {

document [x].visibility = it;
if (type == textDivType)

if (document[shadowDivName])

document[shadowDivName].visibility = it;

}
else if(document.all) {

document.all[x].style.visibility = it;
if (type == textDivType)

if (document.all[shadowDivName])

document.all[shadowDivName].style.visibility=it;

}

}
#PAGEROLL#
//-->
</SCRIPT>
</HEAD>
<BODY #BACKGROUND# #ONLOAD#> #CONTROLS#
<BODY>
<HTML>
Zoom Rule-set
<SCRIPT LANGUAGE=”j avascript”>
var destTop#ID#= new Array(#DESTTOP#); var destLeft#ID#= new
Array(#DESTLEFT#); var destWidth#ID# = new Array(#DESTWIIDTH#); var
destHeight#ID# = new Array(#DESTHEIGHT#);
var top#ID# = new Array(#TOP#); var left#ID# = new Array(#LEFT#); var width#ID# 32
new Array(#WIDTH#); var height#ID# = new Array(#HEIGHT#);
var state#ID# = new Array(#STATEICON#);
var controlList#ID# = new Array(#CONTROLLIST#);
var imgList#ID# = new Array(#PICLIST#);
var Last#ID# = var LastState#ID#”; var pos;
function zoom#ID#(divName) {

for (var i = 0; i <controlList#ID#.length; i++) {

if (controlList#ID#[i] = divName controlList#ID#[i] == Last#ID#) {if

(controlList#ID#[i] == divName)

temp = state#ID#[i];

else if (controlList#ID#[i] = Last#ID#)

temp = LastState#ID#;

pos = i;

if(state#ID#[i] == ‘1’) {

t = destTop#ID#[i];
= destLeft#ID#[i];
w = destWidth#ID#[i];
h = destHeight#ID#[i];
state#ID#[i] = ‘0’;

}

else if(state#ID#[i] == ‘0’) {

t = top#ID#[i];

1 = left#ID#[i];

w = width#ID#[i];
h = height#ID#[i];
state#ID#[i] = ‘1’

}

if (document.layers) {
var x=”<A HREF=\”\##\”

onClick=\”zoom#ID#(’’’+controlList#ID#[i];

x +=‘‘‘);return false;\”><IMG SRC’’’±imgList#ID[i]+‘‘‘‘‘;
x +=“WIDTH=” +w+“HEIGHT=”+h+”

ID=’pic”+controlList#ID#[i]+’’’’’;

x +=“name=’pic”+controlList#ID#[i]+‘‘‘BORDER=0></A>”

obj =document[controlList#ID#[i]]obj.left =1;

obj.top =

obj .document.open( ); obj.document.write(x); obj
.document.close( );

}
else if (document.all) {

obj=document.all[controlList#ID#[i]]style;
obj.left = 1; obj.top = obj.width = w; obj.height = h;
obj =document.all[”pic”+controlListftID#[i]].style;

obj.width = w;

obj.height =

}

}

}
if(Last#ID# !=divName) {

Last#ID# =divName;

LastState#ID# = state#ID#[pos];

}
else {

Last#ID# =

LastState#ID# =

}

}
//-->
</SCRIPT>
#ICONS#
Streaming Video Rule-set
<SCRIPT>
function vidplay( )
{

if (document.layers) {

obj=document.#ID#.document.ns#ID#;
document.ns#ID#.DoPlay( );

}
else if (document.all) ie#ID#.DoPlay( );

}
function vidstop( )
{

if (document.layers) document.ns#ID#.DoStop( );
else if (document.all) ie#ID#.DoStop( );

}
function vidpause( )
{

if (document.layers) document.ns#ID#.DoPause( );
else if (document.all) ie#ID#.DoPause( );

}
//-->
</SCRIPT>
<div ID=”#ID#”name=”#ID#”
style=”position: absolute; left:#X#px; top :#Y#px; width:#W#px;
height:#H#px;topmargin: 0px;leftmargin:0px;”>
<OBJECT CLASSID=”clsid: CFCDAAO3-8BE4- 11 cf-B84B-OO2OAFBBCCFA”
ID=”ie#ID#”

width#W#height=#H#> <PARAM NAME=”controls”
VALUE=”ImageWindow”>
<PARAM NAME=”console VALUE”C lip 1”> <PARAM NAME=”autostart”
VALUE=”#AUTOSTART#”> <PARAM NAME=”src”VALUE”#URL#”>
<EMBED SRC=”#URL#”CONSOLE=”Clip1” HEIGHT=#Hftpx

WIDTH=#W#px

ID=”ns#ID#”NAME=”ns#ID#”
TYPE=”audio/x-pn-realaudio-plugin”
CONTROLS=”ImageWindow”AUTOSTART=”#AUTOSTART#”>

</EMBED>

</OBJECT>
</div>
#ICONS#

1. A system for producing, publishing, distributing, managing, and viewing content over one or more platforms, comprising:
i. a production module operable to produce and publish content for one or more platforms;
ii. a management module operable to store, manage, process and distribute the content; and
iii. a hierarchical communications network operable to serve end users and manage transfer of the content.

2. The system of claim 1, wherein the content comprises at least one content item comprising:
a generic representation of content; and
a plurality of content item displays, each content item display defined for one platform of the one or more platforms, each display operable to display the content on the defined platform using the generic representation of content.

3. The system of claim 2, wherein the production module includes a production sub-system for creating at least one content item for one or more platforms.

4. The system of claim 3, wherein the production module includes a publisher client for publishing at least one content item for one or more platforms.

5. The system of claim 4, wherein the generic representation of content comprises extensible markup language statements.

6. The system of claim 3, wherein the production module further comprises:
an authoring system having a graphical user interface operable to integrate the plurality of displays; and
a preview module operable to preview the displays in alternative platforms.

7. The system of claim 6, wherein the preview module comprises at least one platform converter and platform rule-sets.

8. The system of claim 3, wherein the production module comprises Object-Oriented layered architecture for constructing and managing content item displays.

9. The system of claim 3, wherein the management module comprises:
a publishing server operable to publish content;
a system database operable to process and store assets of the published content in a system database repository;
a plurality of distribution modules operable to distribute the published content to one or more platforms; and
a content management operable to manage the content.

10. The system of claim 3, wherein the hierarchical communications network comprises an interactive intelligent network that includes a plurality of the network servers operable to serve end users, each network server comprising server software for serving optimized content to end users.

11. The system of claim 10, wherein each network server comprises:
a display server module operable to interact with an end user and control the network server operation;
a plurality of platform converters, each platform converter operable to convert data to a format suitable for display on at least one alternative platform by the display server module;
a plurality of object rule-set libraries for supporting the at least one alternative platform;
an application server operable to provide requests from the end user to other network servers for static resources, and operable to transfer the static resources to the network server;
an application server operable to provide requests from the end user to other network servers for streaming resources, and operable to redirect the end user to a selected other network server;
a distribution client operable to distribute a content item from the management module to the network server; and
a plurality of streaming servers operable to support servicing streams of respective video and audio formats.

12. A system for automatically converting content items to alternative platforms, comprising:
at least one content item containing at least one content item display, the content item display having a format and including at least one display object attribute for at least one platform;
at least one objects rule-set comprising a plurality of rules specifying a conversion from the format to a second format supported by a specific platform; and
a converter operable to combine the display object attributes and the object rule-set to generate a display for the specific platform.

13. The system of claim 12, wherein the format is extensible markup language.

14. The system of claim 13, wherein the display for the specific platform comprises code executable to generate the display on the specific platform.

15. The system of claim 14, wherein the code is hypertext markup language.

16. A method for providing a content management system for content creation and delivery over one or more platforms, the method comprising the steps of:
registering and managing users and content items;
producing the content items for content display;
publishing the content items to a content management module;
distributing the content items to targeted platforms;
viewing at least one content item on at least one platform; and
optimizing availability of the content items to users using a hierarchical intelligent network.

17. The method of claim 16, wherein the step of registering and managing users and content items comprises the steps of;
defining users and providing the users with access permissions to content management capabilities; and
creating new content items and configuring content item platforms, associated producer users, and targeted end users profiles for the users.

18. The method of claim 17, wherein the step of producing the content items for content display comprises the step of:
constructing a representation of generic content, including a generic structure of content and a layout of a content display.

19. The method of claim 18, wherein the representation of generic content is implemented using extensible markup language.

20. The method of claim 17, wherein the step of publishing the content items comprises the steps of:
transferring assets and files;
registering the assets in a database; and
transferring registration information.

21. The method of claim 17, wherein the step of distributing the content items comprises the steps of:
setting a time for distribution;
preparing assets and files; and
establishing communication with a distribution agent and sending the files.

22. The method of claim 19, wherein the step of viewing the content items comprises the steps of:
receiving request;
identifying a user platform and searching for content for the identified platform;
obtaining files for the identified platform and converting the files for use by the platform; and
locating assets for the content.
